(19) United States
(12) Patent Application Publication
(10) Pub. No.: US 2008/0008217 A1
(43) Pub. Date: Jan. 10, 2008

(54) Laser device including heat sink with a tailored coefficient of thermal expansion

(75) Inventors: Robert L. Miller, Tucson, AZ (US); Raman Srinivasan, Tucson, AZ (US)

Correspondence Address: ORION LAW GROUP, 3 HUTTON CENTRE, SUITE 850, SANTA ANA, CA, 92707, US

(73) Assignee: Newport Corporation, Irvine, CA (US)

(21) Appl. No.: 11/482,367

(22) Filed: Jul. 7, 2006

(51) Int. Cl. H01S 3/04

(52) U.S. Cl. 372/36; 372/34

(57) ABSTRACT

A laser module comprising a laser device attached to a heat sink that is configured to provide a relatively low thermal resistance for thermal management of the laser device, and a coefficient of thermal expansion (CTE) that is substantially matched to the CTE of the laser device for reducing stress caused by thermal cycles and bonding. In one embodiment, the heat sink comprises a substrate made out of a first material, and including one or more via holes filled with a second material distinct from the first material of the substrate. By properly selecting the first and second materials, configuring the overall mass of the substrate with respect to the overall mass of the filled via holes, and positioning and arranging the filled via holes with respect to the laser device, the desired effective thermal resistance and CTE for the heat sink may be achieved. In another embodiment, the laser module comprises a laser device attached to a submount, which is, in turn, attached to a heat sink. In this embodiment, the submount is configured as the heat sink discussed above.

### BACKGROUND

Laser devices, such as semiconductor lasers, are used in many applications, such as medical, imaging, ranging, welding, cutting, and many other applications. Some of these are low power applications, and others are high power applications. In high power applications, semiconductor lasers are exposed to relatively high temperatures. High temperatures on semiconductor lasers may cause damage to the devices, and typically reduce their performance characteristics including their expected operational life. Accordingly, heat sinks are typically provided with semiconductor lasers for thermal management purposes. This is better explained with reference to the following example.

FIG. 1 illustrates a side view of an exemplary conventional laser module 100. The laser module 100 consists of a laser device 102, such as a gallium-arsenide (GaAs) semiconductor laser device, and a heat sink 104 typically made of a relatively high thermal conductivity material, such as copper (Cu). The GaAs laser device 102 is attached to the Cu heat sink 104 via a bonding material 106, such as solder. The Cu material, which has a relatively high thermal conductivity of approximately 380 Watts per meter Kelvin (W/mK), serves as an adequate thermal management tool for the semiconductor laser device 102. However, as discussed below, there are also adverse issues associated with the use of the Cu heat sink 104.

In relatively high power applications, continuous wave (CW) or pulsed applications, the laser module 100 may be subjected to relatively high temperatures. Additionally, the laser module 100 may also be subjected to frequent thermal cycles, between room temperature and the high operating temperatures of the device. Because of the substantially difference in the coefficients of thermal expansion (CTE) of GaAs (e.g., approximately 6.5 parts per million per degree Kelvin (ppm/C) ) and Cu (e.g., approximately 17 ppm/C), the thermal cycle that the laser module 100 undergoes creates substantial stress on the GaAs laser device 102. Such stress may cause cracks in the laser device 102, which may, in turn, cause the device to fail.

To alleviate this problem, the bonding material 106 is generally made out of a soft solder, such as Indium-based solders. Soft solders are typically used as the bonding material 106 because they have a relatively low melting temperature and have the ability to creep. Their creeping ability allows the soft solder to absorb some of the stress that develop on the laser device 102 as a result of thermal cycles. However, it has been observed that intermetallic compounds formed during the bonding process with soft solders lead to solder fatigue and, ultimately, to premature failure. Additionally, in a pulsing operational mode of the laser device 102, it has been observed that electromechanical solder migration occurs in soft solders.

Harder solders, such as gold-tin (AuSn), may be used as the bonding material 106 because they are less susceptible to thermal fatigue than soft solders, and have high strength that result in elastic rather than plastic deformation. However, AuSn solder is not generally a good candidate for the bonding material 106 because they do not have the creeping properties that soft solders have, and thus, the hard solder does not absorb well the stress developed on the laser device 102 during thermal cycling.

### SUMMARY

An aspect of the invention relates to a laser module comprising a laser device attached to a heat sink. The heat sink is configured to provide a relatively low thermal resistance for thermal management of the laser device. The heat sink is also configured to provide a coefficient of thermal expansion (CTE) that is substantially matched to the CTE of the laser device. In particular, the heat sink comprises a substrate made out of a first material. The substrate includes one or more via holes filled with a second material distinct from the first material of the substrate. By properly selecting the first and second materials, configuring the overall mass of the substrate with respect to the overall mass of the filled via holes, and positioning and arranging the filled via holes with respect to the laser device, the desired effective thermal resistance and CTE for the heat sink may be achieved.

In one embodiment, the CTE of the substrate is less than the CTE of the laser device. Accordingly, to increase the effective CTE of the heat sink from that of the substrate towards the CTE of the laser device, the CTE of the via hole material is greater than the CTE of the laser device. In another embodiment, the CTE of the substrate is greater than the CTE of the laser device. Accordingly, to decrease the effective CTE of the heat sink from that of the substrate towards the CTE of the laser device, the CTE of the via hole material is less than the CTE of the laser device. With reference to both embodiments, by properly selecting the substrate material and via hole material, and determining the sizes and quantity of the filled via holes and their position and arrangement with respect to the laser device, the desired effect thermal resistance for thermal management and the desired CTE for stress reduction may be achieved.

Another aspect of the invention relates to a laser module comprising a laser device attached to a submount which is, in turn, attached to a heat sink. The submount and the heat sink are configured to provide a relatively low thermal resistance for thermal management of the laser device. The submount is further configured to provide a CTE that is substantially matched to the CTE of the laser device. In particular, the submount comprises a substrate made out of a first material. The substrate includes one or more via holes filled with a second material distinct from the first material of the substrate. By properly selecting the first and second materials, configuring the overall mass of the substrate with respect to the overall mass of the filled via holes, and positioning and arranging the filled via holes with respect to the laser device, the desired thermal resistance and effective CTE for the submount may be achieved.

Other aspects, advantages and novel features of the present invention will become apparent from the following detailed description of the invention when considered in conjunction with the accompanying drawings.

### BRIEF DESCRIPTION OF THE DRAWINGS

FIG. 1 illustrates a side view of an exemplary conventional laser module including a heat sink for thermal management;

FIG. 2A illustrates a side cross-sectional view of an exemplary laser module in accordance with an embodiment of the invention;

FIG. 2B illustrates a top perspective view of an exemplary heat sink in accordance with another embodiment of the invention;

FIG. 2C illustrates a top perspective view of another exemplary heat sink in accordance with another embodiment of the invention; and

FIG. 3 illustrates a side sectional view of another exemplary laser module in accordance with an embodiment of the invention.

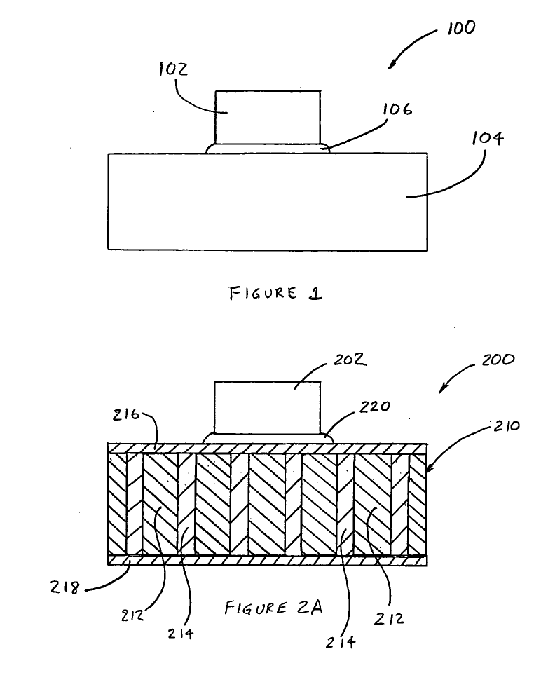

### DETAILED DESCRIPTION

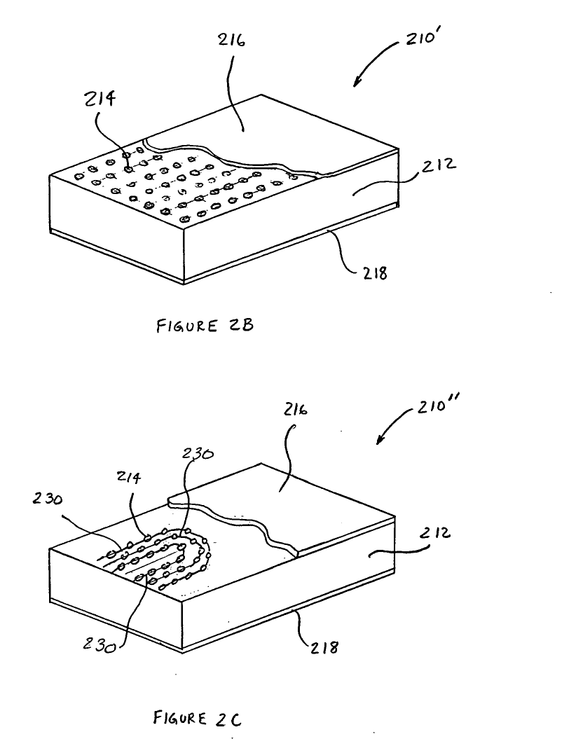

FIG. 2A illustrates a side cross-sectional view of an exemplary laser module 200 in accordance with an embodiment of the invention. The laser module 200 comprises a laser device 202, a heat sink 210, and a bonding material 220 for securely attaching the laser device 202 to the heat sink 210. The heat sink 210, in turn, comprises a substrate 212 including one or more via holes filled with a particular type of material 214. The heat sink 210 further comprises a top material layer 216 and a bottom material layer 218. In this example, the bonding material 220 attaches the laser device 202 to the top material layer 216 of the heat sink 210.

More specifically, the laser device 202 may be any type of laser device mountable on a heat sink. For example, the laser device 202 may be a semiconductor laser diode or other type of laser device. Some specific examples of semiconductor laser devices include galium-arsenide (GaAs) lasers, indium-phosphide (InP) lasers, and others. For the purpose of discussing the exemplary embodiment of the heat sink 210, the GaAs semiconductor laser serves as the particular example. However, it shall be understood that the invention is not limited to a GaAs semiconductor laser, and encompasses other types of lasers as discussed above.

The heat sink 210 achieves at least a couple of objectives. First, the heat sink 210 acts as a relatively low thermal resistance device to remove heat from the laser device 202. Second, the heat sink 210 has an effective coefficient of thermal expansion (CTE) that is substantially matched with the CTE of the laser device 202 such that stress developed on the laser device 202 during thermal cycling is substantially reduced. In accordance with these aims, the selection of the materials for the substrate 212 and the via holes 214 is such that the heat sink 210 has a relatively low thermal resistance and has an effective CTE that is substantially matched with the CTE of the laser device 202.

As an example, for the purpose of providing a relatively low thermal resistance for the heat sink 210, the substrate 212 may be comprised of a dielectric having a relatively high thermal conductivity, such as aluminum-nitride (AlN), also known as ceramic. For example, AlN has a thermal conductivity of approximately 180 W/mK. In addition, the via hole material 214 should also have a relatively high thermal conductivity, such as Cu. For example, Cu has a thermal conductivity 380 W/mK.

For the purpose of substantially matching the effective CTE of the heat sink 210 to the CTE of the laser device 202, a number of parameters need to be properly selected, including the selection of the materials for the substrate 212 and the via holes 214, the mass of the substrate 212 with respect to the overall mass of the via hole material 214, and the position and arrangement of the filled via holes 214 with respect to the laser device 202.

As an example, the CTE of a GaAs laser device 202 may be approximately 6.5 ppm/C. The CTE of an AlN substrate 212 may be approximately 4.4 ppm/C. To raise the 4.4 ppm CTE of the AlN substrate 212, a number of Cu filled via holes 214 may be formed within the substrate 212. Since the CTE of Cu is approximately 17 ppm/C, a certain number of Cu-filled via holes 214 would raise the effective CTE of the heat sink 210 so that it is substantially matched with the CTE of the GaAs laser device 202.

The GaAs laser device 202, the AlN substrate 212, and the Cu-filled via holes 214 are merely examples of a particular configuration for the laser module 200. It shall be understood that the materials for the substrate 212 and the filled via holes 214 may vary substantially, depending on the material of the laser device 202, the desired thermal resistance for the heat sink 210, and the desired matching of the effective CTE for the heat sink 210 with the CTE of the laser device 202. Some examples of materials suitable for the substrate 212 include AlN, beryllium oxide (BeO), alumina (Al₂O₃), copper-tungsten (CuW), and others. Some examples of materials suitable for the filled via holes 214 include Cu, silver (Ag), diamond and others.

In general, the selection of the material for the filled via holes 214 should be designed to “move” the effective CTE of the heat sink 210 from the CTE of the substrate 212 towards the CTE of the laser device 202. In the above example, the “movement” was in the positive direction (e.g., from the 4.4 ppm/C of the AlN substrate 212 towards the 6.5 ppm/C of the laser device 202). It shall be understood that the movement may be in the negative direction. For example, the substrate 212 may be comprised of BeO, which has a CTE of approximately 7.6 ppm/C, and the via holes 214 may be filled with chemical vapor deposition (CVD) diamond, which has a CTE of 2.3 ppm/C. Thus, in this case, the CVD-diamond-filled via holes 214 “move” the substrate CTE (7.6 ppm/C) in the negative direction towards the 6.5 ppm/C.

In this example, the top layer 216 of the heat sink 210 may be comprised of Cu, or other suitable material that allows the laser device 202 to attach to the heat sink 210 via the bonding material 220. Similarly, the bottom layer 218 of the heat sink may be comprised of Cu, or other suitable material that allows the heat sink 200 to be bonded (e.g., soldered) onto a fixed surface.

FIG. 2B illustrates a top perspective view of an exemplary heat sink 210′ in accordance with another embodiment of the invention. The heat sink 210′ is similar to the heat sink 210 previously discussed, except that the heat sink 210′ has a particular filled via hole pattern. For instance, in this example, the filled via hole pattern is configured into a rectangular or square array. It shall be understood that the filled via hole pattern may vary substantially. Another example is discussed below.

FIG. 2C illustrates a top view of another exemplary heat sink 210″ in accordance with another embodiment of the invention. In this example, the filled via holes 214 are positioned along isothermal lines 230 around and below the laser device 202. In this manner, the via hole material 214, having a relatively high thermal conductivity, such as Cu or diamond, can easily disperse heat from the laser device; thereby, offering a relatively low thermal resistance.

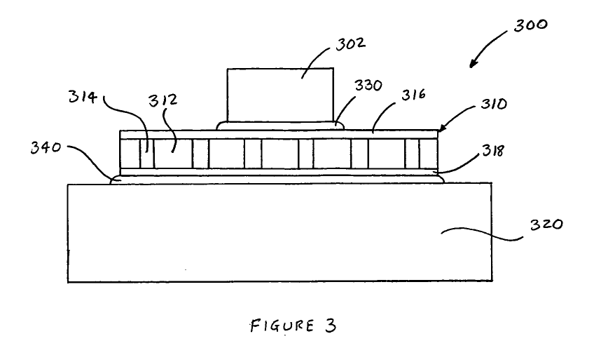

FIG. 3 illustrates a side sectional view of another exemplary laser module 300 in accordance with an embodiment of the invention. The laser module 300 comprises a laser device 302, a heat sink submount 310, and a heat sink 320. The laser device 302 is attached to the submount 310 via a first bonding material 330. The submount 310 is, in turn, attached to the heat sink 320 via a second bonding material 340.

The submount 310 is similarly constructed as the heat sink 210 previously discussed. In this regard, the submount 310 comprises a substrate 312, a plurality of filled via holes 314 situated within the substrate 312, a top material layer 316, and a bottom material layer 318. The laser device 302 attaches to the top material layer 316 of the submount 310 via the first bonding material 330. The bottom material layer 318 of the submount 310 attaches to the heat sink 320 via the second bonding material 340.

Similar to the heat sink 210, the submount 310 may be configured with the heat sink 320 to provide a relatively low thermal resistance for thermal management of the laser device 302. The submount 310 may also be configured to exhibit an effective CTE that is substantially matched to the CTE of the laser device 302 to reduce stress associated with thermal cycling and bonding. As previously discussed, the selection of the materials for the substrate 312 and the via hole material 314, the overall mass of the substrate 312 with respect to the overall mass of the filled via holes 314, and the position and arrangement of the filled via holes with respect to the laser device 302 are parameters that can be selected to provide the desired effective thermal resistance and CTE for the submount 310.

As previously discussed with reference to heat sink 210, the materials for the substrate 312 and via holes 314 may vary substantially, depending on the desired specification for the submount 310. Some examples of materials suitable for the substrate 312 include AlN, beryllium oxide (BeO), alumina (Al₂O₃), copper-tungsten (CuW), and others. Some examples of materials suitable for the filled via holes 314 include Cu, silver (Ag), diamond , and others. In this example, the top layer 316 of the submount 310 may be comprised of Cu, or other suitable material that allows the laser device 302 to attach to the submount 310 via the bonding material 330. Similarly, the bottom layer 318 of the submount 310 may be comprised of Cu, or other suitable material that allows the submount 310 to be attached to the heat sink 320.

In this example, the laser device 302 may be any type of laser device including semiconductor lasers, such as GaAs and InP lasers. The heat sink 320 may be comprised of a relatively high thermal conductive material, such as Cu. It could be configured as a standard heat sink or a specially-designed heat sink. The bonding materials 330 and 340 may be any type of bonding material, such as hard solders, soft solders, epoxy, and others. Alternatively, the submount 310 may be brazed to the heatsink 320.

While an improved laser module device with improved heat sink is disclosed by reference to the various embodiments and examples detailed above, it should be understood that these examples are intended in an illustrative rather than limiting sense, as it is contemplated that modifications will readily occur to those skilled in the art which are intended to fall within the scope of the present invention.

What is claimed is:

1. A laser module, comprising:
a laser device; and
a heat sink to which said laser device is attached, wherein said heat sink comprises a substrate made out of a first material, and including one or more via holes filled with a second material distinct from said first material, wherein an effective CTE of said heat sink is substantially matched with a CTE of said laser device.

2. The laser module of claim 1, wherein said laser device comprises a semiconductor laser.

3. The laser module of claim 2, wherein said laser device comprises GaAs, InP, or any combination thereof.

4. The laser module of claim 1, wherein said heat sink comprises a plurality of said via holes filled with said second material.

5. The laser module of claim 4, wherein said plurality of filled via holes are arranged in said substrate substantially along isothermal lines during operation of said laser device.

6. The laser module of claim 4, wherein said plurality of filled via holes are arranged in said substrate in a rectangular or square array.

7. The laser module of claim 1, wherein said first material of said substrate comprises AlN, BeO, Al₂O₃, CuW, or any combination thereof.

8. The laser module of claim 1, wherein said second material of said via hole comprises Cu, Ag, diamond, or any combination thereof.

9. The laser module of claim 1, wherein said heat sink further comprises a material layer disposed on top of said substrate.

10. The laser module of claim 9, wherein said material layer comprises Cu.

11. The laser module of claim 9, further comprising a bonding material for attaching said laser device to said material layer.

12. The laser module of claim 11, wherein said bonding material comprises a solder or epoxy.

13. The laser module of claim 1, wherein said heat sink further comprises a material layer disposed on the bottom of said substrate.

14. The laser module of claim 13, wherein said material layer comprises Cu.

15. A laser module, comprising:
a laser device having a first CTE; and
a heat sink to which said laser device is attached, wherein said heat sink comprises a substrate made out of a first material having a second CTE, and including one or more via holes filled with a second material having a third CTE, wherein said second CTE is less than said first CTE, and wherein said third CTE is greater than said first CTE.

16. The laser module of claim 15, wherein an effective CTE of said heat sink is substantially matched with said first CTE of said laser device.

17. A laser module, comprising:
a laser device having a first CTE; and
a heat sink to which said laser device is attached, wherein said heat sink comprises a substrate made out of a first material having a second CTE, and including one or more via holes filled with a second material having a third CTE, wherein said second CTE is greater than said first CTE, and wherein said third CTE is less than said first CTE.

18. The laser module of claim 17, wherein an effective CTE of said heat sink is substantially matched with said first CTE of said laser device.

19. A laser module, comprising:
a laser device; and
a submount to which said laser device is attached, wherein said submount comprises a substrate made out of a first material, and including one or more via holes filled with a second material distinct from said first material, wherein an effective CTE of said submount is substantially matched with a CTE of said laser device; and
a heat sink to which said submount is attached.

20. The laser module of claim 19, wherein said submount comprises a plurality of said via holes filled with said second material.

21. The laser module of claim 20, wherein said plurality of filled via holes are arranged in said substrate substantially along isothermal lines during operation of said laser device.

22. The laser module of claim 19, wherein said first material of said substrate comprises AlN, BeO, Al₂O₃, CuW, or any combination thereof.

23. The laser module of claim 19, wherein said second material of said via hole comprises Cu, Ag, diamond, or any combination thereof.

24. The laser module of claim 19, wherein said submount further comprises a material layer disposed on a top of said substrate.

25. The laser module of claim 24, further comprising a bonding material for attaching said laser device to said material layer.

26. The laser module of claim 19, wherein said submount further comprises a material layer disposed on a bottom of said substrate.

27. The laser module of claim 26, further comprising a bonding material for attaching said material layer to said heat sink.

28. The laser module of claim 19, wherein said heat sink comprises copper.

29. The laser module of claim 19, wherein said submount is brazed to said heat sink.

30. A laser module, comprising:
a laser device having a first CTE; and
a submount to which said laser device is attached, wherein said submount comprises a substrate made out of a first material having a second CTE, and including one or more via holes filled with a second material having a third CTE, wherein said second CTE is less than said first CTE, and wherein said third CTE is greater than said first CTE; and
a heat sink to which said submount is attached.

31. The laser module of claim 30, wherein an effective CTE of said submount is substantially matched with said first CTE of said laser device.

32. A laser module, comprising:
a laser device having a first CTE; and
a submount to which said laser device is attached, wherein said submount comprises a substrate made out of a first material having a second CTE, and including one or more via holes filled with a second material having a third CTE, wherein said second CTE is greater than said first CTE, and wherein said third CTE is less than said first CTE; and
a heat sink to which said submount is attached.

33. The laser module of claim 32, wherein an effective CTE of said submount is substantially matched with said first CTE of said laser device.
